(19) United States
(12) Patent Application Publication
(10) Pub. No.: US 2018/0209451 A1
(43) Pub. Date: Jul. 26, 2018

(54) SYSTEMS AND METHODS FOR MAINTAINING HYDRAULIC ACCUMULATORS

(71) Applicant: Sikorsky Aircraft Corporation, Stratford, CT (US)

(72) Inventor: Brian D. LeFevre, Webster, NY (US)

(21) Appl. No.: 15/736,444

(22) PCT Filed: Jun. 14, 2016
(86) PCT No.: PCT/US16/37397

§ 371 Date: Dec. 14, 2017

Related U.S. Application Data
(60) Provisional application No. 62/181,626, filed on Jun. 18, 2015.

(51) Int. Cl. F15B 19/00; F15B 1/08; F15B 21/04

(52) U.S. Cl. CPC F15B 19/005; F15B 1/08; F15B 2201/51; F15B 2201/505; F15B 21/045

(57) ABSTRACT

A method for diagnosing leaks in a hydraulic accumulator includes measuring the time required to discharge the hydraulic accumulator to determine an actual discharge duration. The method includes comparing the actual discharge duration to an expected discharge duration to generate a condition indicator. The condition indicator correlates to the presence or absence of a leak.

### CROSS REFERENCE TO RELATED APPLICATIONS

This application claims benefit of U.S. Provisional Application No. 62/181,626, filed Jun. 18, 2015, the entire disclosure of which is hereby incorporated herein by reference in its entirety.

### SYSTEMS AND METHODS FOR MAINTAINING HYDRAULIC ACCUMULATORS STATEMENT REGARDING FEDERALLY SPONSORED RESEARCH OR DEVELOPMENT

This invention was made with government support under contract number W911 W6-10-2-0006 awarded by the United States Army. The government has certain rights in the invention.

### BACKGROUND OF THE INVENTION

### 1. Field of the Invention

The present disclosure relates to hydraulic accumulators, and more particularly to diagnosing leaks in hydraulic accumulators.

### 2. Description of Related Art

Many aircraft, for example, rotoraft, include hydraulic accumulators. Maintenance of hydraulic accumulators due to leakage of nitrogen gas charge can be a significant maintenance driver in some aircraft. Existing maintenance checks are manual, for example visual inspection. Manual maintenance checks are not always accurate, which can lead to unnecessary labor intensive re-charging of the accumulator.

Such conventional methods and systems have generally been considered satisfactory for their intended purpose. However, there is still a need in the art for improved methods and systems for diagnosing leaks in hydraulic accumulators. The present disclosure provides a solution for this need.

### SUMMARY OF THE INVENTION

A method for diagnosing leaks in a hydraulic accumulator includes measuring the time required to discharge the hydraulic accumulator to determine an actual discharge duration. The method includes comparing the actual discharge duration to an expected discharge duration to generate a condition indicator. The condition indicator correlates to the presence or absence of a leak.

The method can include generating a look-up table of expected discharge durations using a physics-based accumulator model that correlates expected discharge duration of a leak free accumulator to a variety of local ambient temperatures. Measuring the time required to discharge the hydraulic accumulator can include measuring elapsed time between opening of a start valve and tripping of a low-pressure switch. The method can include measuring a local ambient temperature and selecting the expected discharge duration, which corresponds to the measured local ambient temperature, from the look-up table. Comparing the actual discharge duration to the expected discharge duration can include taking the difference between the actual discharge duration and the expected discharge duration. The condition indicator can be equal to the difference between the actual discharge duration and the expected discharge duration.

It is contemplated that the method can include determining accumulator health and/or gas chamber pressure by using the local ambient temperature to select the accumulator health or gas chamber pressure from another look-up table. The method can include generating an indication of at least one of accumulator health or gas chamber pressure and transmitting the indication of at least one of accumulator health and/or gas chamber pressure to other diagnostic and prognostic tools for the purpose of further analysis The method can include selecting minimum and maximum condition indicator thresholds from another look-up table generated by a physics-based accumulator model exercised at gas chamber pressure levels corresponding to established corrective maintenance thresholds. The method can include determining whether a corrective maintenance action is required by comparing the condition indicator to the minimum and maximum condition indicator thresholds and generating an alert signaling a need for a maintenance action if the condition indicator is less than the minimum condition indicator threshold, and/or greater than the maximum condition indicator threshold.

In another aspect, a hydraulic accumulator leak assessment system includes a hydraulic accumulator having a gas chamber. A start valve is operatively connected to the hydraulic accumulator to control the release of the hydraulic charge from the hydraulic accumulator. A start valve status sensor is operatively connected to the start valve to determine whether the start valve is open or closed. A low-pressure switch is operatively connected to the gas chamber to be activated when the gas chamber pressure reaches a pre-determined threshold. A temperature sensor is operatively connected to the hydraulic accumulator to measure the local ambient temperature to which the hydraulic accumulator is exposed. A leak assessment module operatively connected to the start valve status sensor, the low-pressure switch and the temperature sensor to determine whether a leak is present in the hydraulic accumulator based on an assessment of a condition indicator corrected for the measured local ambient temperature and derived from elapsed time between opening of the start valve and tripping of the low-pressure switch.

The leak assessment module can include at least one of a look-up table and an equation. Each of the look-up table and equation can be based on a physics-based accumulator model that correlates discharge time to varied levels of pressure in the gas chamber for a variety of ambient temperatures to generate a condition indicator and temperature-dependent minimum and maximum condition indicator threshold values.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a vertical take-off and landing (VTOL) aircraft, showing an accumulator leak assessment system constructed in accordance with the present disclosure;

FIG. 2 is a schematic view of the accumulator leak assessment system of FIG. 1, showing the low-pressure switch, start valve, and ambient temperature sensor; and

FIG. 3 is a flowchart of an exemplary method for diagnosing leaks in a hydraulic accumulator in accordance with the present disclosure, showing operations for comparing the actual discharge duration to an expected discharge duration that has been corrected for a measured local ambient temperature.

### DETAILED DESCRIPTION OF THE PREFERRED EMBODIMENTS

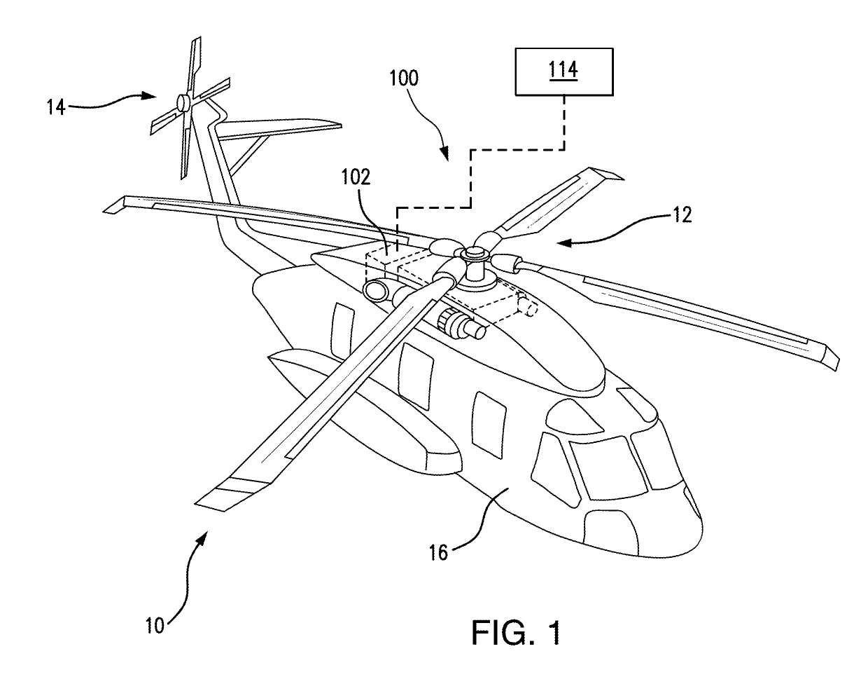

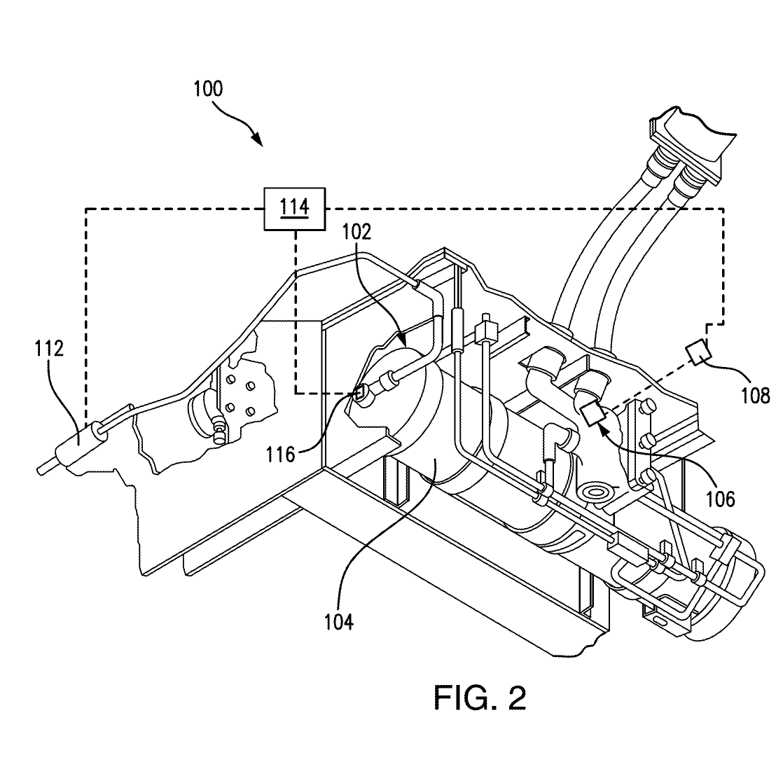

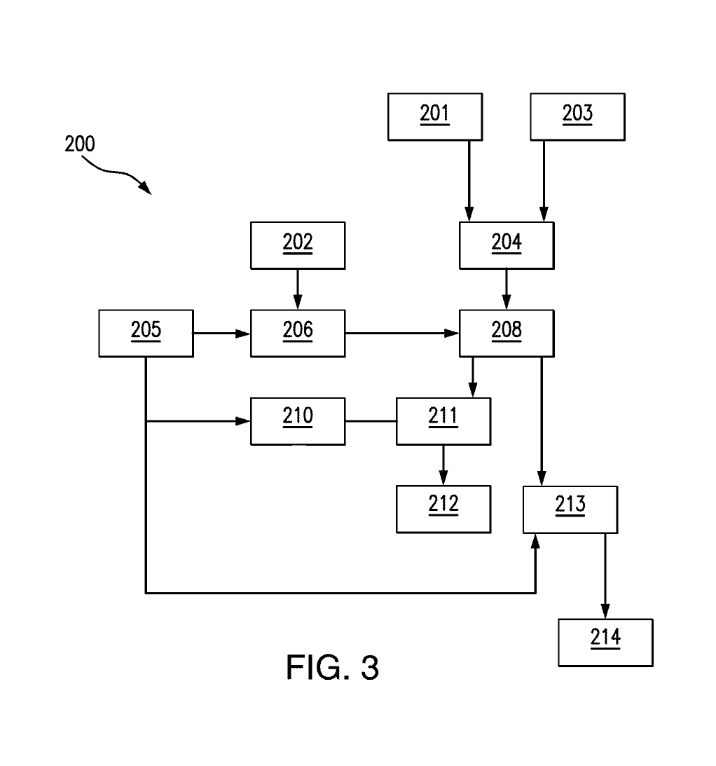

Reference will now be made to the drawings wherein like reference numerals identify similar structural features or aspects of the subject disclosure. For purposes of explanation and illustration, and not limitation, a partial view of an exemplary embodiment of a vertical takeoff and landing (VTOL) aircraft in accordance with the disclosure is shown in FIG. 1 and is designated generally by reference character 10. Other embodiments of VTOL aircraft in accordance with the disclosure, or aspects thereof, are provided in FIGS. 2-3, as will be described.

As shown in FIG. 1, VTOL aircraft 10 includes a main rotor system 12 and tail rotor system 14 supported by an airframe 16. VTOL aircraft 10 also includes a hydraulic accumulator leak assessment system 100 having a hydraulic accumulator 102 operatively connected to a leak assessment module 114 Those skilled in the art will readily appreciate that while hydraulic accumulator leak assessment system 100 is described in the context of a VTOL aircraft, system 100 can be used in a variety of aerospace and industrial applications.

Accumulator leak assessment system 100 includes an automated accumulator diagnostic module, e.g. leak assessment module 114, described in more detail below, that alleviates the maintenance burden of traditional hydraulic accumulator systems by reducing and/or eliminating manual maintenance inspections for leaks. Accurate diagnostic indications minimize unnecessary maintenance efforts and costs due to misdiagnosis, for example, they reduce the probability of hydraulic accumulators being removed with “no fault found”. Moreover, false diagnoses of other aircraft system problems whose root cause could include a leaking hydraulic accumulator, e.g., gas path degradation of the Auxiliary Power Unit (APU) as a cause for slow APU starts, can be avoided by accurately diagnosing a leaky accumulator.

With reference now to FIG. 2, hydraulic accumulator 102 has a gas chamber 104 and a start valve 106 operatively connected to hydraulic accumulator 102 to control the release of the hydraulic charge from hydraulic accumulator 102. A start valve status sensor 108 is operatively connected to start valve 106 to determine whether start valve 106 is open or closed. A tow-pressure switch 112 is operatively connected to gas chamber 104 to be activated when pressure in gas chamber 104 reaches a pre-determined threshold. System 100 includes a temperature sensor 116 operatively connected to hydraulic accumulator 102. Those skilled in the art will readily appreciate that temperature sensor 116 can be in a variety of suitable locations with respect to hydraulic accumulator 102, as long as temperature sensor 116 is located in the proximity of hydraulic accumulator 102 to measure the ambient temperature to which hydraulic accumulator 102 is exposed.

With continued reference to FIG. 2, a leak assessment module 114 is operatively connected to start valve status sensor 108, low-pressure switch 112, and temperature sensor 116 to determine whether a leak is present in hydraulic accumulator 102 based on the measured elapsed time, e.g. actual discharge duration, between opening start valve 106, which releases the hydraulic charge from hydraulic accumulator 102, and tripping of low-pressure switch 112, which senses when pressure in gas chamber 104 of hydraulic accumulator 102 has reached a pre-determined threshold, described in more detail below. Leak assessment module 114 applies appropriate corrections based on the ambient temperature measured by temperature sensor 116. Leak assessment module 114 includes at least one of a look-up table and an equation. Each of the look-up table and equation is based on a physics-based accumulator model that correlates expected discharge duration to varied levels of pressure in gas chamber 104 for a variety of ambient temperatures to characterize the presence or absence of a leak in hydraulic accumulator 102.

As shown in FIG. 3, a method. 200 for diagnosing leaks in a hydraulic accumulator, e.g. hydraulic accumulator 102, is included in a memory in the form of instructions operatively connected to be read by a processor in leak assessment module 114. When the instructions are read by the processor, leak assessment module 114 performs method 200. Method 200 includes generating a look-up table of expected discharge durations using a physics-based accumulator model that correlates expected discharge duration of a leak free accumulator at a variety of local ambient temperatures, as indicated by box 202. Method 200 includes measuring the time required to discharge the hydraulic accumulator to determine an actual discharge duration for the hydraulic accumulator, indicated by box 204, by measuring elapsed tithe between opening of a start valve, e.g. start valve 106, as captured by start valve status sensor 108, and tripping of a low-pressure switch, e.g. low-pressure switch 112, as indicated by boxes 201 and 203. Low pressure switch 112 is a discrete on/off switch that is set to trip at a pre-determined pressure threshold. Method 200 includes measuring a local ambient temperature, as indicated by box 205, and selecting the expected discharge duration, which corresponds to the measured local ambient temperature, from the look-up table, as indicated, by box 206. In this way, method 200 compensates for changes in discharge time due to varied ambient temperature.

Method 200 includes comparing the actual discharge duration to the expected discharge duration by taking the difference between the actual discharge duration and the expected discharge duration, as indicated by box 208. The difference between the actual discharge duration and the expected discharge duration is the value of the condition indicator. Method 200 includes determining accumulator health or gas chamber pressure, as indicated by box 213, by using the ambient temperature measurement and condition indicator value to select the appropriate accumulator health or gas chamber pressure value from another look-up table, which is generated by the physics-based accumulator model and correlates the value of the condition indicator to the pressure in gas chamber 104 as a function of measured ambient temperature. Method 200 includes generating an indication of at least one of accumulator health or gas chamber pressure and transmitting the indication of accumulator health and/or gas chamber pressure to other diagnostic and prognostic tools, as indicated by box 214, for the purpose of further analysis.

With continued reference to FIG. 3, method 200 includes selecting minimum and maximum condition indicator thresholds from another look-up table generated by the physics-based accumulator model exercised at gas chamber pressure levels corresponding to established corrective maintenance thresholds, i.e., minimum and maximum allowable gas chamber pressures, by using the physics-based accumulator model to estimate the discharge duration for the hydraulic accumulator at the measured local ambient temperature and established gas chamber pressure limits, and then calculating the minimum and maximum condition indicator threshold values by taking the difference between the estimated discharge duration at each of the allowable gas chamber pressure limits for the measured ambient temperature, and the expected discharge duration of a leak free accumulator at the measured ambient temperature, as indicated by box 210. In this way, the minimum and maximum condition indicator thresholds correspond to the expected values of the condition indicator when the gas chamber pressure has reached its minimum and maximum allowable values, respectively, at the measured ambient temperature.

Method 200 includes determining whether a corrective maintenance action is required by comparing the condition indicator to the minimum and maximum condition indicator thresholds, as indicated by box 211. Method 200 includes generating an alert signaling a need for a corrective maintenance action if the condition indicator is less than or greater than the minimum and maximum condition indicator thresholds, respectively, as indicated by box 212, respectively. A condition indicator less than the minimum condition indicator threshold for the given local ambient temperature indicates that gas chamber pressure has dropped below the minimum allowable pressure, and that corrective maintenance is required. A condition indicator value above the maximum condition indicator threshold for the given local ambient temperature indicates that the gas chamber pressure is above the allowable limits, i.e. that the maintainer over-charged the accumulator. If the condition indicator is between the minimum and maximum condition indicator thresholds, no alert signaling a need for a corrective maintenance action is generated.

The methods and systems of the present disclosure, as described above and shown in the drawings, provide for systems and methods for diagnosing leaks in a hydraulic accumulator, including optimization of maintenance of hydraulic accumulators, and reduction in maintenance time and costs. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A method for diagnosing leaks in a hydraulic accumulator, the method comprising:
measuring the time required to discharge a hydraulic accumulator to determine an actual discharge duration; and
comparing the actual discharge duration to an expected discharge duration to generate a condition indicator, wherein the condition indicator correlates to the presence or absence of a leak.

2. A method as recited in claim 1, wherein measuring the time required to discharge the hydraulic accumulator includes measuring elapsed time between opening of a start valve and tripping of a low-pressure switch.

3. A method as recited in claim 1, further comprising generating a look-up table of expected discharge durations using a physics-based accumulator model that correlates the expected discharge durations of a leak free accumulator to a variety of local ambient temperatures.

4. A method as recited in claim 3, further comprising measuring a local ambient temperature and selecting the expected discharge duration, which corresponds to the measured local ambient temperature, from the look-up table.

5. A method as recited in claim 1, wherein comparing the actual discharge duration to the expected discharge duration includes taking the difference between the actual discharge duration and the expected discharge duration.

6. A method as recited in claim 5, wherein the condition indicator is equal to the difference between the actual discharge duration and the expected discharge duration.

7. A method as recited in claim 1, further comprising measuring a local ambient temperature and determining at least one of accumulator health or gas chamber pressure by using the local ambient temperature to select the accumulator health or gas chamber pressure from another look-up table.

8. A method as recited in claim 7, further comprising generating an indication of at least one of accumulator health or gas chamber pressure.

9. A method as recited in claim 8, further comprising transmitting the indication of at least one of accumulator health and/or gas chamber pressure to other diagnostic and prognostic tools for the purpose of further analysis.

10. A method as recited in claim 1, further comprising selecting minimum and maximum condition indicator thresholds from another look-up table generated by a physics-based accumulator model exercised at gas chamber pressure levels corresponding to established corrective maintenance thresholds.

11. A method as recited in claim 10, further comprising determining whether a corrective maintenance action is required by comparing the condition indicator to the minimum and maximum condition indicator thresholds and generating an alert signaling a need for the corrective maintenance action if the condition indicator is less than the minimum condition indicator threshold.

12. A method as recited in claim 10, further comprising determining whether a corrective maintenance action is required by comparing the condition indicator to minimum and maximum condition indicator thresholds and generating an alert signaling a need for the corrective maintenance action if the condition indicator is greater than the maximum condition indicator threshold.

13. A hydraulic accumulator leak assessment system comprising:
a hydraulic accumulator having a gas chamber;
a start valve operatively connected to the hydraulic accumulator to control the release of the hydraulic charge from the hydraulic accumulator;
a start valve status sensor operatively connected to the start valve to determine whether the start valve is open or closed;
a low-pressure switch operatively connected to the gas chamber to be activated when the gas chamber pressure reaches a pre-determined threshold;
a temperature sensor operatively connected to the hydraulic accumulator to measure the ambient temperature to which the hydraulic accumulator is exposed; and
a leak assessment module operatively connected to the start valve status sensor, the low-pressure switch and the temperature sensor to determine whether a leak is present in the hydraulic accumulator based on an assessment of a condition indicator corrected for the ambient temperature and derived from elapsed time between opening of the start valve and tripping of the low-pressure switch.

14. A system as recited in claim 13, wherein the leak assessment module includes at least one of a look-up table and an equation, wherein each of the look-up table and equation is based on a physics-based accumulator model that correlates discharge time to varied levels of pressure in the gas chamber for a variety of ambient temperatures to generate a condition indicator and temperature-dependent minimum and maximum condition indicator threshold values.
